(19) United States
(12) Patent Application Publication
(10) Pub. No.: US 2008/0296120 A1
(43) Pub. Date: Dec. 4, 2008

(54) Bell housing

(75) Inventor: David G. Flory, Burbank, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Probell Racing Products, Co.

(21) Appl. No.: 11/806,325

(22) Filed: May 31, 2007

(51) Int. Cl. F16D 65/00; B21D 26/02

(52) U.S. Cl. 192/112; 29/421.1

(57) ABSTRACT

A bi-metallic bell housing that includes an inner layer and an outer layer. The inner layer includes a first metallic material and the outer layer includes a second metallic material. Also, the inner layer is configured to be positioned adjacent to an automotive clutch and an automotive flywheel and to at least partially surround each of the clutch and the flywheel. The outer layer is mechanically bonded to the inner layer.

### FIELD OF THE INVENTION

The present invention relates generally to automotive components and to methods of making thereof. More particularly, the present invention relates to bell housings and methods of making bell housings.

### BACKGROUND OF THE INVENTION

Drag racing is a motorsport competition where, typically, two automobiles race side-by-side along a straight track and attempt to travel a set distance (usually a quarter-mile) as quickly as possible. Like many other automobiles used for motorsports, automobiles designed for drag racing are typically lighter and substantially more powerful than standard automobiles. As such, elite drag racers can attain speeds well above 300 miles per hour and travel the quarter-mile distance in under 4.5 seconds.

In view of the incredible power generated by drag racing vehicles, a number of safety precautions have been implemented in the design of such vehicles. One such safety measure is the bell-shaped housing or bell housing. Typically, the bell housing encases the vehicle's clutch and flywheel. As such, the bell housing prevents either of these components from causing injury to either the driver or spectators, should either of these components become detached from the rest of the vehicle. The bell housing also minimizes the clutch and flywheel's ability to cause damage to the remainder of the vehicle, again, should either of these components become detached.

Typically, currently available bell housings are made from low-carbon steel. Low-carbon steel is chosen since this material provides a great deal of strength, yet is also relatively lightweight. However, titanium bell housings are also available. Titanium bell housings also provide a high degree of strength. Titanium bell housings are also more lightweight than their low-carbon steel counterparts. However, titanium bell housings are more expensive and more difficult to manufacture that those made of low-carbon steel.

At least in view of the above, it would be desirable to provide bell housings that are strong enough to meet the requirements of drag racing, yet that are lightweight, relatively inexpensive, and relatively straightforward to manufacture. It would also be desirable to provide relatively straightforward methods of manufacturing bell housings that meet the requirements of drag racing, yet that are lightweight and relatively inexpensive.

### SUMMARY OF THE INVENTION

The foregoing needs are met, to a great extent, by certain embodiments of the present invention. According to one such embodiment, a bi-metallic housing is provided. The housing includes an inner layer that itself includes a first metallic material. According to this embodiment, the inner layer is configured to be positioned adjacent to an automotive clutch and an automotive flywheel and to at least partially surround each of the clutch and the flywheel. The housing also includes an outer layer that itself includes a second metallic material. According to this embodiment, the outer layer is mechanically bonded to the inner layer.

In accordance with another embodiment of the present invention, a method of manufacturing a bi-metallic housing is provided. The method includes the step of placing a first component including a first metallic material adjacent to a second component including a second metallic material. The method also includes hydroforming a bi-metallic bell housing from the first component and the second component. The housing is configured to be positioned adjacent to an automotive clutch and an automotive flywheel and to at least partially surround each of the clutch and the flywheel.

In accordance with still another embodiment of the present invention, another bi-metallic housing is provided. The housing includes strengthening means for strengthening a bell housing. The strengthening means is configured to be positioned adjacent to an automotive clutch and an automotive flywheel and to at least partially surround each of the clutch and the flywheel. The housing also includes weight-reducing means for reducing overall weight of the bell housing. The weight-reducing means is mechanically bonded to the strengthening means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a bell housing according to an embodiment of the present invention.

FIG. 2 is a first cross-sectional view of the bell housing illustrated in FIG. 1, taken along A-A in FIG. 1.

FIG. 3 is a second cross-sectional view of the bell housing illustrated in FIG. 1, taken along B-B in FIG. 1.

FIGS. 4-9 illustrates steps of a manufacturing process according to one embodiment of the present invention for forming the bell housing illustrated in FIGS. 1-3.

### DETAILED DESCRIPTION

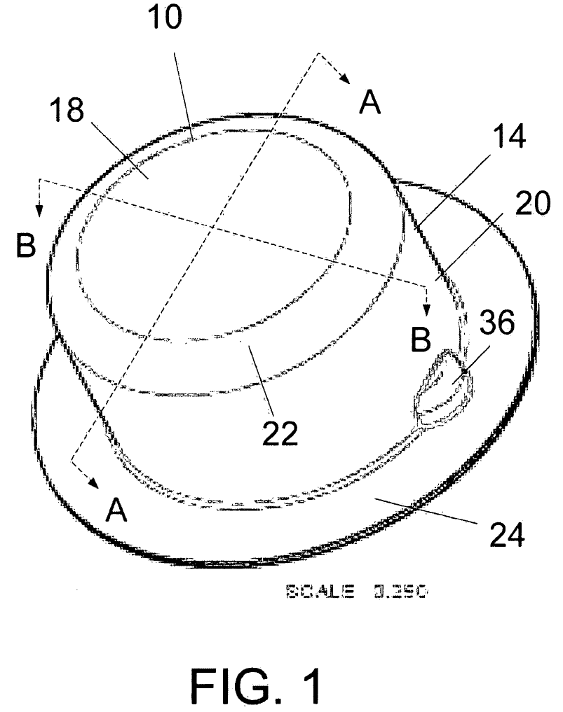

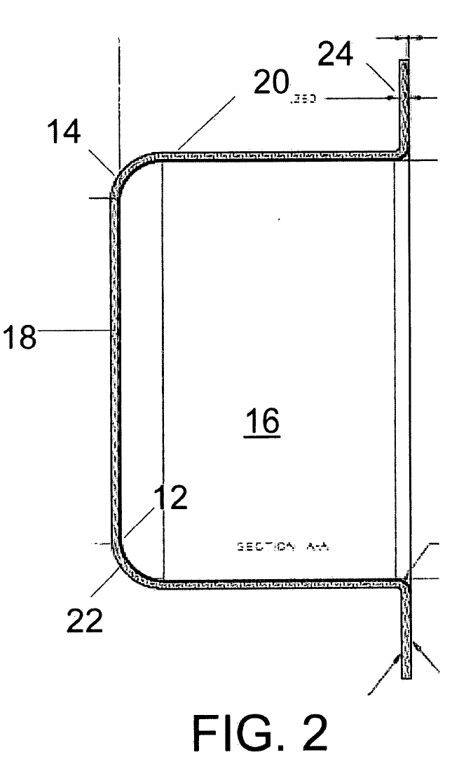

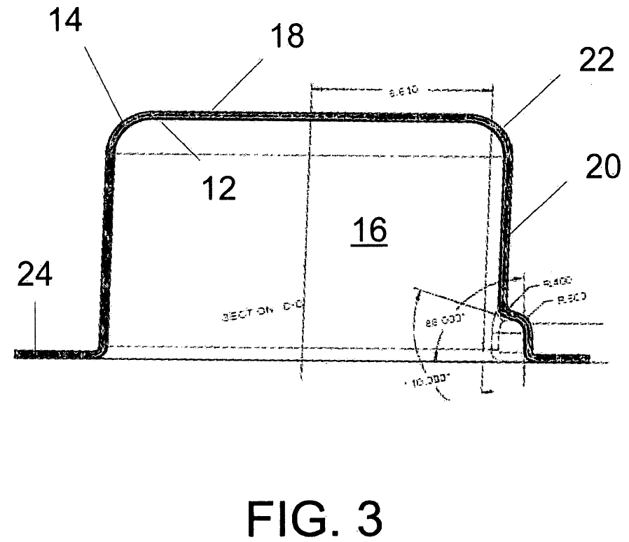

The invention will now be described with reference to the drawing figures, in which like reference numerals refer to like parts throughout. FIG. 1 is a perspective view illustrating a bell housing 10 according to an embodiment of the present invention. FIG. 2 is a first cross-sectional view of the bell housing 10 illustrated in FIG. 1, taken along A-A in FIG. 1. FIG. 3 is a second cross-sectional view of the bell housing illustrated in FIG. 1, taken along B-B in FIG. 1.

The bell housing 10 illustrated in FIGS. 1-3 is bi-metallic and, as such, includes an inner layer 12 made from a first metallic material and an outer layer 14 made from a second metallic material. According to certain embodiments of the present invention, the inner layer 12 and the outer layer 14 are mechanically bonded to each other. More specifically, as illustrated in FIGS. 2 and 3, the outer layer 14 is mechanically bonded to an exterior surface of the inner layer 12. How the bond between the inner layer 12 and the outer layer 14 is formed according to certain embodiments of the present invention is discussed below in the discussion of a process that may be used to manufacture the bell housing 10.

According to certain embodiments of the present invention, the above-discussed bell housing 10 is included in a vehicle specially designed for drag racing. As such, the bell housing 10 is configured to be positioned adjacent to a clutch and a flywheel (not illustrated) of the drag racing vehicle and to at least partially surround each of the clutch and the flywheel. In order for this function to be implemented, typically, the clutch and the flywheel are at least partially inserted into the cavity 16 of the bell housing 10 illustrated in FIGS. 2 and 3.

According to certain embodiments of the present invention, the inner layer 12 of the bi-metallic bell housing 10 is made from a stainless steel alloy. As will be mentioned again below during the discussion of the manufacturing process of the bell housing 10, according to certain embodiments, 304 stainless steel (a low-carbon stainless steel) is used to form the entire inner layer 12. According to some of these embodiments, the 304 stainless steel is cold rolled, annealed, and pickled before being formed into the inner layer 12. However, the use of other materials (typically metals and/or metallic alloys) to form the inner layer 12 is also within the scope of certain embodiments of the present invention.

According to certain embodiments of the present invention, the outer layer 14 of the housing 10 is made from an aluminum alloy. According to some of these embodiments, a 6061 aluminum alloy is used to. As will be discussed further below in the discussion of the process for forming the bell housing 10, according to certain embodiments of the present invention, a 6061-T651 aluminum alloy is anneal in order to form a 6061-0 aluminum alloy. The 6061-0 aluminum alloy is then age hardened to the 6061-T4 alloy, which is ultimately incorporated into the bell housing 10. However, the use of other materials (typically metals and/or metallic alloys) to form the outer layer 14 is also within the scope of certain embodiments of the present invention.

As illustrated in FIG. 1, the bell housing 10 includes a substantially circular surface 18. Typically, when portions of the above-discussed clutch and flywheel are positioned in the cavity 16 of the bell housing 10, the circular surface 18 is positioned above the clutch and flywheel.

The bell housing 10 also includes a substantially cylindrical surface 20. As illustrated in FIGS. 1-3, the cylindrical surface 20 is connected to the circular surface 18 and is positioned substantially perpendicular thereto. Also, the cylindrical surface 20 extends substantially continuously around the bell housing 10. Although a curved surface 22 is illustrated in FIGS. 1-3 as being positioned between the circular surface 18 and the cylindrical surface 20, bell housings wherein the circular surface 18 and the cylindrical surface 20 are in direct contact with (i.e., abut) each other are also within the scope of the present invention.

In addition to the above-mentioned surfaces 18, 20, 22, the bell housing 10 illustrated in FIGS. 1-3 also includes a flange 24. As illustrated in FIGS. 1-3, the flange 24 of the bell housing 10 is connected to directly to the edge of the cylindrical surface 20 opposite the circular surface 18. The flange 24 typically protrudes radially from the cylindrical surface 20 and allows for the entire bell housing 10 to be attached to a drag racing vehicle. More specifically, the flange 24 may have holes formed therein through which bolts may be passed to secure the bell housing 10 to a portion of a drag racing vehicle. As an alternative, the flange 24 may be clamped to the vehicle or slid into a slot on the vehicle.

As illustrated in FIGS. 1 and 3, the bell housing 10 also includes a starter pocket 36 formed within the curved surface 22. The top of the starter pocket 36 is adjacent to the cylindrical surface 20, the bottom of the starter pocket 36 is adjacent to the flange 24, and the starter pocket 36 itself defines a cavity designed to accommodate insertion of a protrusion extending from the portion of the vehicle to which the bell housing 10 is to be affixed. Although the starter pocket 36 discussed above is of a semi-arcuate geometry, other geometries are also within the scope of certain embodiments of the present invention (e.g., semi-spherical, rectangular, etc.).

According to certain embodiments of the present invention, the starter pocket 36 facilitates the proper orientation of the bell housing 10 relative to the vehicle to which the bell housing 10 is to be attached. The starter pocket 36 comes in particularly handy when the flange 24 includes a plurality of holes through which bolts or other fasteners are passed in order to secure the bell housing 10 to a vehicle.

According to certain embodiments of the present invention, the substantially circular surface 18, the substantially cylindrical surface 20, the curved surface 22, and the flange 24 are all formed as one continuous component. However, according to other embodiments of the present invention, one or more of the surfaces 18, 20, 22, and the flange 24 may be formed separately and subsequently attached to the remainder of the bell housing 10.

In the bell housing 10 illustrated in FIGS. 1-3, each of the surfaces 18, 20, 22, and the flange 24 have an inner layer made from a stainless steel alloy and an outer layer made from an aluminum alloy. However, according to other embodiments of the present invention, more or less than two materials or alloys may be used to form any or all of the components of the bell housing 10 illustrated in FIGS. 1-3.

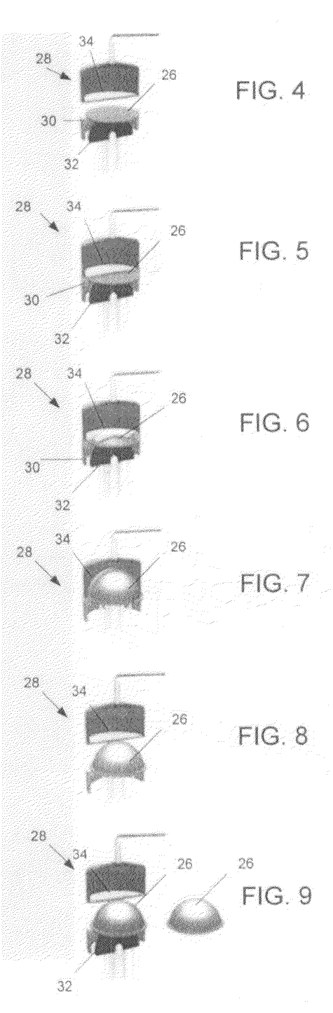

FIGS. 4-9 illustrates steps of a manufacturing process according to one embodiment of the present invention for forming the bell housing 10 illustrated in FIGS. 1-3. FIG. 4 illustrates a blank 26 placed on a draw ring 30 of a hydroforming machine 28. According to certain embodiments of the present invention, the blank 26 includes a substantially circular piece of stainless steel alloy placed down on the draw ring 30 and a substantially circular piece of aluminum alloy placed on top of the piece of stainless steel. In other words, in FIG. 4, the piece of stainless steel is placed adjacent to a male punch 32 included in a lower portion of the hydroforming machine 28 and the piece of aluminum alloy is placed adjacent to the female bladder 34 included in an upper portion of the hydroforming machine 28

FIG. 5 illustrates how the bladder 34 (i.e., a flexible die member) is lowered onto the blank 26. Once the bladder 34 is positioned on the blank 26, according to certain embodiments of the present invention, the upper and lower portions of the hydroforming machine 28 are locked together so as to prevent the blank 26 from moving therein.

FIG. 6 illustrates how, once the blank 26 is secured in the hydroforming machine 26, the pressure in the bladder 34 is established to a pre-determined setting. According to certain embodiments of the present invention, the pressure in the bladder 34 is increased by filling the bladder 34 with pressurized oil or some other hydraulic fluid. A pressure of up to approximately 10,000 psi or more may ultimately be applied to the blank 26 illustrated in FIGS. 4-9. When the above-discussed blank 26 dimensions are used, forces of approximately 650,000 pounds or more may be applied to the blank 26.

FIG. 7 illustrates how, once the bladder 34 has been pressurized to a desired level, the punch 32 is moved upwards within the hydroforming machine 28. As illustrated in FIG. 7, this upward movement of the punch not only deforms the blank 26 but also the bladder 34.

Once the punch 32 has been moved a desired distance into the bladder 34, the bladder 34 is raised away from the punch 32, as illustrated in FIG. 8. Typically, as also illustrated in FIG. 8, the blank 26, which now effectively has the geometry of a bell housing according to certain embodiments of the present invention, remains on the punch 32.

In the final step of the process illustrated in FIGS. 4-9, the punch 32 is stripped from the blank 26, which is now in the form of the newly formed bell housing as illustrated in FIG. 9. This step is typically done by applying mechanical force to dislodge the blank 26 from the punch 32.

It will be noted by one of skill in the art that the blank 26 illustrated in FIG. 9 and the bell housing 10 illustrated in FIGS. 1-3 do not have identical geometries. This merely exemplifies that bell housings according to the present invention may vary in size and shape. In order to form the shape of the bell housing 10, the punch 32 in the hydroforming machine 28 could be exchanged with an alternate punch having a different geometry. For example, square or rectangular punches may be used, as well as punches with more complex geometries.

It will also be appreciated by one of skill in the art, upon practicing certain embodiments of the present invention, that alternate hydroforming processes may be used. For example, the punch 32 discussed above could be positioned at the top of the hydroforming machine 28 and be lowered.

As will be appreciated by one of skill in the art upon practicing one or more embodiments of the present invention, the use of the above-discussed stainless steel and aluminum alloys will allow for the manufacture of a relatively lightweight and relatively strong bell housing 10. However, as will also be appreciated by one of skill in the art upon performing the manufacturing process described herein, the manufacturing process is relatively straightforward and inexpensive.

According to certain embodiments of the present invention, before being placed on the draw ring 30, the stainless steel that eventually forms the inner layer 12 of the bell housing 10 discussed above is rolled, annealed and pickled. Also, the 6061-T651 aluminum alloy that eventually forms the outer layer of the bell housing is annealed at approximately 775° F. for between approximately 2 and 3 hours. Then, the aluminum alloy is cooled at a rate of approximately 50° F. per hour until the alloy reaches a temperature of approximately 500° F. Pursuant to being cooled to approximately 500° F., any cooling rate and/or method may be used to bring the aluminum alloy to a temperature at which the aluminum alloy may be placed in the hydroforming machine 28 (e.g., room temperature).

According to the process illustrated in FIGS. 4-9, the piece of stainless steel positioned on the draw ring 30 in FIG. 4 is an 18-gauge (i.e., 0.048-inch) piece of 304 stainless steel sheet. The stainless steel sheet is also of a substantially “doughnut” shape that includes an opening in the center thereof and an 11¾-inch internal diameter. Since the aluminum alloy is softer than the stainless steel alloy used to form the bell housing 10, the central opening in the piece of stainless steel essentially functions as a release valve that allows for expansion as the bell housing 10 is formed in the hydroforming machine 28.

The piece of aluminum alloy used to form the above-discussed bell housing 10, according to one embodiment of the present invention, is a sheet of ¼″ aluminum 6061 drawn back (i.e., subjected to a heat treatment process that includes annealing or normalizing the aluminum alloy) to 0 form. According to this process, once a piece of 6061-T6 aluminum alloy is drawn back to the 6061-0 form (which is a normalized aluminum), then the aluminum alloy is aged for at least approximately 90 days to a 6061-T4 form, which gives the desired properties for containment and longevity of certain bell housings according to the present invention.

Once formed, bell housings according to certain embodiments of the present invention are capable of achieving the standards set forth in the SFI 6.3 Certification Tests. As such, bell housings according to the present invention are configured to withstand the explosion of a flywheel therein.

Although the above-discussed manufacturing process utilizes stainless steel and aluminum alloys, the use of other materials is also within the scope of the present invention. Typically, however, materials having similar coefficients of friction and yield percentages are chosen. So long as those materials properties are similar, the materials will form together (i.e., without one material getting ahead of the other in the forming process as the punch 32 comes up and hydraulic pressure is increased).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A bi-metallic bell housing, comprising:
an inner layer including a first metallic material, wherein the inner layer is configured to be positioned adjacent to an automotive clutch and an automotive flywheel and to at least partially surround each of the clutch and the flywheel; and
an outer layer including a second metallic material, wherein the outer layer is mechanically bonded to the inner layer.

2. The bi-metallic bell housing of claim 1, wherein the inner layer substantially completely surrounds each of the clutch and the flywheel.

3. The bi-metallic bell housing of claim 1, wherein the inner layer comprises a stainless steel alloy.

4. The bi-metallic bell housing of claim 1, wherein the outer layer comprises an aluminum alloy.

5. The bi-metallic bell housing of claim 1, wherein the inner layer comprises 304 stainless steel and wherein the outer layer comprises 6061 aluminum.

6. The bi-metallic bell housing of claim 1, wherein the inner layer comprises:
a substantially circular surface; and
a substantially cylindrical surface connected to the substantially circular surface and positioned substantially perpendicular thereto.

7. The bi-metallic bell housing of claim 6, further comprising:
a flange connected to the substantially cylindrical surface and protruding therefrom.

8. The bi-metallic bell housing of claim 7, wherein the substantially circular surface, the substantially cylindrical surface, and the flange are all formed as one continuous component.

9. The bi-metallic bell housing of claim 6, further comprising a starter pocket formed within the cylindrical surface.

10. A method of manufacturing a bell housing, the method comprising:
placing a first component including a first metallic material adjacent to a second component including a second metallic material; and
hydroforming a bi-metallic bell housing from the first component and the second component, wherein the housing is configured to be positioned adjacent to an automotive clutch and an automotive flywheel and to at least partially surround each of the clutch and the flywheel.

11. The method of claim 10, further comprising:
forming the first component to have a substantially ring shape with an inner diameter and an outer diameter.

12. The method of claim 10, wherein the placing step comprises selecting the first component to include stainless steel and selecting the second component to include an aluminum alloy.

13. The method of claim 12, wherein the placing step comprises selecting the first component to include 304 stainless steel and the second component to include 6061 aluminum.

14. The method of claim 10, wherein the hydroforming step comprises utilizing a pressure of approximately 10,000 psi.

15. The method of claim 10, further comprising:
annealing the second component prior to the hydroforming step.

16. The method of claim 15, wherein the annealing step comprises:
heating the second component to approximately 775° F. for between approximately 2 and 3 hours; and
cooling the second component at a rate of approximately 50° F. per hour until the second component reaches a temperature of approximately 500° F.

17. The method of claim 16, further comprising:
aging the second component for at least approximately 90 days pursuant to the heating step.

18. The method of claim 10, further comprising:
rolling the first component;
annealing the first component; and
pickling the first component, wherein the rolling step, the annealing step and the pickling step all take place prior to the hydroforming step.

19. The method of claim 10, wherein the hydroforming step comprises forming a starter pocket in the bell housing.

20. The method of claim 10, wherein the hydroforming step comprises forming a flange in the bell housing.

21. The method of claim 10, wherein the hydroforming step comprises forming the bell housing to withstand the explosion of a flywheel therein.

22. A bi-metallic bell housing, comprising:
strengthening means for strengthening a bell housing, wherein the strengthening means is configured to be positioned adjacent to an automotive clutch and an automotive flywheel and to at least partially surround each of the clutch and the flywheel; and
weight-reducing means for reducing overall weight of the bell housing, wherein the weight-reducing means is mechanically bonded to the strengthening means.
